(19) United States
(12) Patent Application Publication
(10) Pub. No.: US 2012/0091346 A1
(43) Pub. Date: Apr. 19, 2012

(54) NDIR-two Beam Gas Analyser And Method For Determining The Concentration Of A Measuring Gas Component in a Gas Mixture by means of Said type of Gas Analyser

(75) Inventors: Ralf Bitter, Karlsruhe (DE); Camiel Heffels, Stutensee-Buchig (DE); Thomas Hörner, Karlsruhe (DE); Martin Kionke, Karlsruhe (DE); Michael Ludwig, Karlsruhe (DE)

(73) Assignee: SIEMENS AKTIENGESELLSCHAFT, Muenchen (DE)

(21) Appl. No.: 13/321,738

(22) PCT Filed: May 18, 2010
(86) PCT No.: PCT/EP2010/056770

§ 371 Date: Jan. 4, 2012

(30) Foreign Application Priority Data
May 19, 2009 (DE) 10 2009 021 829.7

(51) Int. Cl. G01J 5/54; G01J 5/10

(52) U.S. Cl. 250/341.7; 250/345

(57) ABSTRACT

The invention relates to a NDIR two beam gas analyser in which infrared radiation is guided by modulation in an alternating manner through a measuring chamber and a reference chamber and is subsequently detected, a measurement signal being produced due to the analysis which determines the concentration of a measurement gas component present in the measurement chamber. The detection and compensation of error effects, in particular modifications on the infrared radiation source or detector arrangement, is simplified as a phase imbalance is produced in the switching of the radiation between the chambers, and the measurement signal is detected in a phase-sensitive manner for modulating the radiation, a measurement signal vector (SF) comprising amplitude information and phase information (Φ_{F}) is obtained such that during calibration of the gas analyser for different known concentrations (K₁, K₂, K₃, K₄, K₅) of the measurement gas components, measurement signal vectors (S₁, S₂, S₃, S₄, S₅) having different amplitudes and phases are determined, vectors define a characteristic line (43), and when an unknown concentration of the gas component is measured, the unknown concentration of the measurement gas component is determined from the intersection point (45) of an obtained measurement signal vector (S_{F}) or the extension thereof with the characteristic line (43).

### CROSS-REFERENCE TO RELATED APPLICATIONS

This is a U.S. national stage of application No. PCT/EP2010/056770 filed 18 May 2010. Priority is claimed on German Application No. 10 2009 021 829.7 filed 19 May 2009, the content of which is incorporated herein by reference in its entirety.

### BACKGROUND OF THE INVENTION

1. Field of the Invention

The invention relates to a method for determining the concentration of a measurement gas component in a gas mixture using a non-dispersive infrared (NDIR) two beam gas analyzer.

The invention furthermore relates to a NDIR two beam gas analyzer.

2. Description of the Related Art

WO 2008/135416 A1 discloses a conventional method and a gas analyzer which serve for determining the concentration of a measurement gas component in a gas mixture. To this end, infrared radiation generated by an infrared radiation source is guided alternately through a measurement cell receiving the gas mixture and a reference cell containing a reference gas. The radiation exiting the two cells is detected using a detector array, where a measurement signal is generated and subsequently evaluated in an evaluation unit. Typical detector arrays include one or more optopneumatic detectors comprising single-layer or double-layer receivers. The radiation is switched between the measurement cell and reference cell using a modulator, which is typically a paddle wheel or chopper. If, for zeroing purposes, both cells are filled with the same gas, i.e., zero gas such as nitrogen or air, and the gas analyzer is optically balanced, the same radiation intensity always reaches the detector array with the result that no measurement signal (change signal) is generated. If the measuring cell is filled with the gas mixture to be examined, pre-absorption that is dependent on the concentration of the measurement gas component contained therein and of any cross gases that may be present occurs. As a result, different radiation intensities temporally sequentially reach the detector array in step with the modulation from the measurement cell and the reference cell, which detector array generates as a measurement signal a change signal with the frequency of the modulation and a variable that is dependent on the difference of the radiation intensities.

The radiation intensity that is incident on the detector array is, however, not just dependent on the gas-specific absorption but also on other variables influencing the intensity of the infrared radiation. Influence variables of this type, such as dirt-, ageing- or temperature-related changes at the infrared radiation source or detector array cannot be readily identified and can lead to incorrect measurement results.

It is necessary for this reason to calibrate the gas analyzer at regular intervals where, for example, the measurement cell is filled successively with zero gas and span gas, i.e., known concentrations of the measurement gas.

For calibrating a NDIR two beam gas analyzer, DE 195 47 787 C1 discloses filling of the measurement cell with a zero gas and interruption of the radiation passing through the reference cell using an aperture. In this way, a one-beam functionality of the gas analyzer is achieved, which enables referencing, for example, to the intensity of the infrared radiation source, without the need to fill the measurement cell with a calibration gas.

In the case of a NDIR two beam gas analyzer known from EP 1 640 708 A1, at least two dark phases are generated within the modulation period, during which the radiation passing through both the measurement cell and through the reference cell is interrupted. In this way, a harmonic with double the frequency is modulated onto the fundamental of the measurement signal. After a Fourier analysis of the measurement signal has been performed, measurement variables normalized by the two first Fourier components are determined and the concentration of the measurement gas component is determined by coordinate transformation of the normalized measurement variables.

In the case of the NDIR two beam gas analyzer known from the already mentioned WO 2008/135416 A1, the detector array has at least two one-layer receivers, which each provide one measurement signal and are located one after the other in the beam path of the gas analyzer. The first one-layer receiver contains, for example, the measurement gas component and the at least one one-layer receiver arranged downstream contains a cross gas. The evaluation unit contains an n-dimensional calibration matrix corresponding to the number n of the one-layer receivers, in which calibration matrix measurement signal values, which are obtained at different known concentrations of the measurement gas component in the presence of different known cross gas concentrations, are stored as n-tuples. When measuring unknown concentrations of the measurement gas component in the presence of unknown cross gas concentrations, the concentration of the measurement gas component is ascertained by comparing the n-tuples of signal values obtained during the measurement with the n-tuples of signal values stored in the calibration matrix. Moreover, for example, if the cross gas concentrations are kept constant, the intensity of the generated radiation can be varied to ascertain the influence of transmittance changes, which are caused by ageing of the infrared emitter or dirt on the measurement cell, on the measurement result.

### SUMMARY OF THE INVENTION

It is an object of the invention to simplify detection of and compensation for error influences, such as dirt-, ageing- or temperature-related changes at an infrared radiation source or detector array.

This and other objects and advantages are achieved in accordance with the invention by a method and NDIR two beam gas analyzer wherein a phase imbalance in switching of radiation between a measurement cell and a reference cell is produced, a measurement signal is detected phase-sensitively with respect to modulation of the radiation, where a measurement signal vector with amplitude information and phase information is obtained. In accordance with the invention, in the calibration of the gas analyzer, measurement signal vectors of different amplitude and phase, which define a characteristic curve, are ascertained for different known concentrations of the measurement gas component, and in the measurement of an unknown concentration of the measurement gas component, the unknown concentration of the measurement gas component is ascertained from the intersection point of the measurement signal vector, obtained in the measurement, or its extension with the characteristic curve.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For the purposes of further illustrating the invention, reference is made below to the figures of the drawing; specifically, the figures show in each case in the form of an exemplary embodiment, in which:

FIG. 1 is a schematic block diagram of a NDIR two beam gas analyzer with a detector array which consists of two one-layer receivers, which are located one downstream of the other, and supplies two measurement signals in accordance with the invention;

FIG. 2 is a graphical plot of a calibration matrix, in which measurement signal values, which are obtained with different known concentrations of the measurement gas component in the presence of different known cross gas concentrations, are stored as value pairs in accordance with the invention;

FIG. 3 is a plan view of an arrangement of chopper, measurement cell and reference cell of the NDIR gas analyzer in accordance with the invention;

FIG. 4 is a graphical plot of the power density distribution of the radiation introduced into the measurement cell and reference cell in accordance with the invention;

FIG. 5 is a graphical plot of an alternative power density distribution of the radiation introduced into the measurement cell and reference cell in accordance with the invention;

FIG. 6 is a graphical plot of a double lock-in amplifier for phase-sensitive detection of a measurement signal and its decomposition into an in-phase component and a quadrature component; in accordance with the invention;

FIG. 7 is a graphical plot of a coordinate system (in-phase component and quadrature component) with a characteristic curve formed from different measurement signal vectors ascertained during a calibration of the gas analyzer for different known concentrations of the measurement gas component in accordance with the invention;

FIG. 8 is a graphical plot of an exemplary rotation of the characteristic curve in the coordinate system for simplifying the measurement signal processing in accordance with the invention;

FIG. 9 is a graphical plot of an exemplary measurement signal processing if the characteristic curve is linear; and

FIG. 10 is a flow chart of the method in accordance with an embodiment of the invention.

### DETAILED DESCRIPTION OF THE PREFERRED EMBODIMENTS

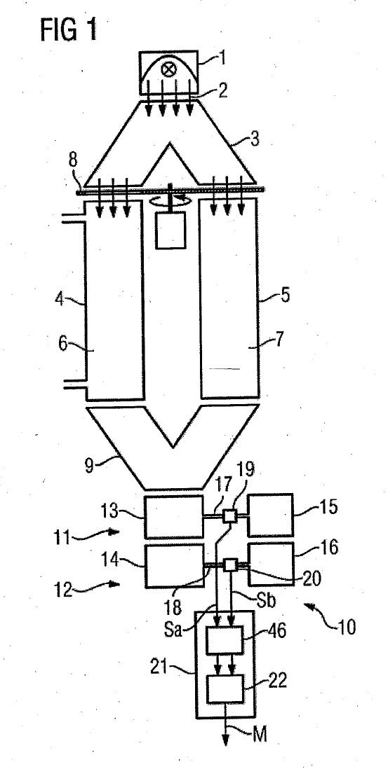

FIG. 1 shows an NDIR two beam gas analyzer, in which the infrared radiation 2 generated by an infrared radiation source 1 is split, using a beam splitter 3 (i.e., a “trouser chamber”), into a measurement beam path passing through a measurement cell 4 and a comparison beam path passing through a reference cell 5. A gas mixture 6 with a measurement gas component, the concentration of which is to be determined, can be introduced into the measurement cell 4. The reference cell 5 is filled with a reference gas 7. A modulator 8, arranged between the beam splitter 3 and the cells 4 and 5, in the shape of a rotating chopper or paddle wheel is used to let through and block infrared radiation 2 alternately through the measurement cell 4 and reference cell 5, with the result that radiation passes alternately through both cells 4 and 5. The radiation, which emerges alternately from the measurement cell and the reference cell 5, is guided, using a radiation collector 9, into a detector array 10, which in the exemplary embodiment shown consists of a first one-layer receiver 11 and a downstream, further one-layer receiver 12. Each of the two one-layer receivers 11, 12 has an active detector chamber 13 or 14, which receives the infrared radiation 2 exiting the cells 4, 5, and a passive compensation chamber 15 or 16, which is arranged outside the radiation 2, with the detector chambers and compensation chambers being connected to one another through a connection line 17 or 18 having a pressure-sensitive or flow-sensitive sensor 19 or 20 arranged therein. Sensors 19 and 20 generate measurement signals Sa and Sb, on the basis of which an evaluation unit 21 ascertains, as measurement result M, the concentration of the measurement gas component in the gas mixture 6. The measurement signal Sb of the second one-layer receiver 12 includes, in addition to the main signal component generated by the radiation absorption in the active detector chamber 14 of the second one-layer receiver 12, also a smaller signal component from the first one-layer receiver 11. The measurement signals Sa and Sb of the two one-layer receivers 11 and 12 therefore form a two-dimensional result matrix. If the detector array 10 consists of n one-layer receivers which are arranged one after the other, n measurement signals Sa, Sb, . . . Sn are obtained, which form an n-dimensional result matrix. If the first one-layer receiver 11 contains the measurement gas component and the downstream n−1 one-layer receivers are filled with different cross gases, the concentration of the measurement gas component can also be ascertained in the presence of these cross gases in different concentrations.

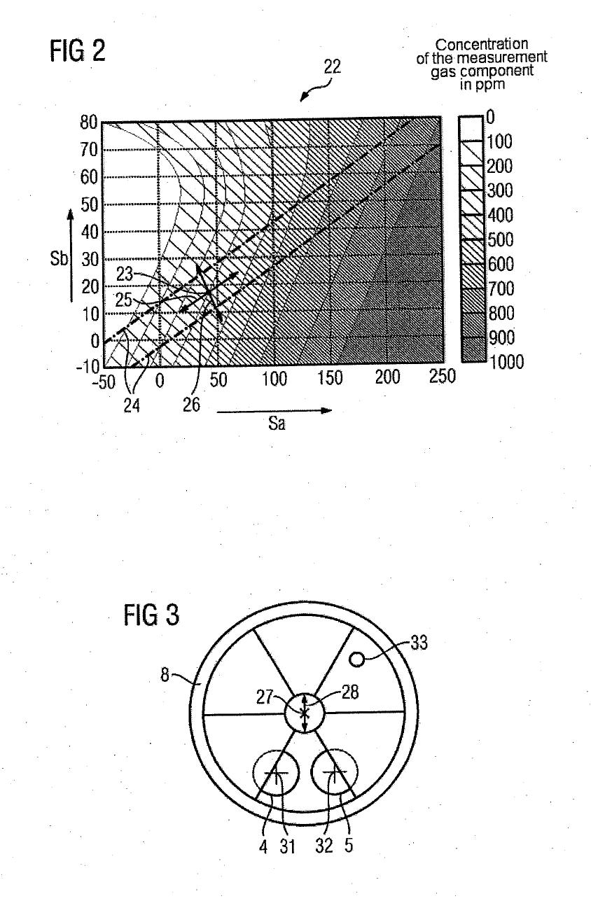

The evaluation unit 21 contains a calibration matrix 22, which corresponds to the abovementioned result matrix and which is shown in detail in FIG. 2 and is used to explain further the mode of operation of the detector array 10.

Different cross gas concentrations with different concentrations of the measurement gas component are fed successively into the measurement cell 4. For each available concentration, one value pair 23 of the signals Sa and Sb is measured, as is shown by way of example in the table which follows. Based on the recorded value pairs of the signals Sa and Sb and the associated known concentration values of the measurement gas component, the calibration matrix 22 is compiled, with intermediate values being formed by interpolation of the recorded or known support values. The calibration matrix 22 can also be stored in the evaluation unit 21 as a mathematical function describing it and the associated function parameters. A reduced measurement series according to the table can suffice for compiling the calibration matrix 22.

| Measurement gas | Cross gas component | | |
|---|---|---|---|
| component in ppm | in ppm | Sa | Sb |
| 0 (zero gas) | 0 | . . . | . . . |
| 0 | 5000 | . . . | . . . |
| 0 | 10000 | . . . | . . . |
| 0 | 15000 | . . . | . . . |
| 500 | 0 | . . . | . . . |
| 500 | 5000 | . . . | . . . |
| 500 | 10000 | . . . | . . . |
| 500 | 15000 | . . . | . . . |
| 1000 (span gas) | 00 | . . . | . . . |
| 1000 | 5000 | . . . | . . . |
| 1000 | 10000 | . . . | . . . |
| 1000 | 15000 | . . . | . . . |

For real measurement situations, generally the cross gases and the fluctuation ranges of their concentrations that can be expected are known (for example, minimum 5000 ppm to maximum 15000 ppm), with the result that a corridor 24 can be defined in the calibration matrix 22, within which the value pairs 23, which are dependent on the concentrations of the measurement gas component and of the known cross gases, will normally fall. For variable concentrations of the measurement gas component, the value pairs 23 move in the direction designated 25 and, for the variable concentrations of the cross gases that can be expected, they move in the direction designated 26. Therefore, if for successive measurements the value pair 23 moves in a direction that also has, in addition to a component in the direction 25, a component in the direction 26, the cross gas influence on the measurement result can be compensated for by ascertaining the direction component 26 and computationally moving the value pair 23 back by this component 26. With the value pair that is corrected in this manner, the calibration matrix 22 gives the correct value of the concentration of the measurement gas component. The movement directions 25 and 26 can, however, be superimposed with additional movement directions which result from fluctuations of further measurement-specific and/or apparatus-specific parameters, such as the output of the infrared emitter 1 or dirt on the measurement cell 4. This makes it difficult to distinguish between cross gas influences and other error influences and to correct the measurement result accordingly.

In order to separate cross gas influences from other error influences such as dirt-, ageing- or temperature-related changes at the infrared radiation source 1 or detector array 10, a fixed phase imbalance in the switching of the radiation 2 between the measurement cell 4 and the reference cell 5 is initially produced.

As shown in FIG. 3, for this purpose, for example, the rotational axis 27 of the chopper or paddle wheel 8 can be offset with respect to the measurement cell 4 and the reference cell 5 in the direction of the arrow 28. In accordance with the illustration in FIG. 4, the power density distribution 29 and 30 of the radiation 2 that is introduced into the cells 4 and 5 using the beam splitter 3 is symmetrical with respect to the axes 31 and 32 of the two cells 4 and 5. The periodic change between allowing the radiation 2 to pass through the measurement cell 4 and interrupting it occurs using a small phase shift of for example 1° in phase opposition to the change between allowing the radiation 2 to pass through the reference cell 5 and interrupting it, with this small phase shift constituting the phase imbalance in the switching of the radiation 2 between the measurement cell 4 and the reference cell 5. Finally, FIG. 3 shows a light barrier 33 for detecting the current position of the chopper or paddle wheel 8.

As shown in FIG. 5, the phase imbalance in the switching of the radiation 2 between the cells 4 and 5 can, alternatively to the offset of the rotational axis 27 of the chopper or paddle wheel 8 (shown in FIG. 3), be produced by introducing the radiation 2 into the measurement cell 4 and reference cell 5 by the beam splitter 3 asymmetrically with respect to the axes 31, 32 of the two cells 4 and 5. Another possibility for producing the phase imbalance is by changing the distance between the two cells 4 and 5.

Due to the phase imbalance, the measurement signals Sa and Sb contain, in addition to amplitude information, phase information. While the measurement gas component and cross gases in the measurement cell 4 influence both the amplitude and the phase of the respective measurement signal Sa or Sb, intensity changes of the infrared radiation 2, which affect the beam paths in both cells 4 and 5 in equal measure, affect only the amplitude of the respective measurement signal Sa or Sb. Such changes in intensity of the infrared radiation 2 which affect the beam paths in both cells 4 and 5 in equal measure can result in particular from dirt-, ageing- or temperature-related changes at the infrared radiation source 1 or detector array 10. By separating the amplitude information and phase information of the measurement signals Sa and Sb, it is thus possible to distinguish between influences on the measurement result M owing to measurement and cross gases, on the one hand, and to changes at the infrared radiation source 1 and detector array 10, on the other hand, and the measurement result M can be corrected accordingly.

In order to separate the amplitude information and phase information, for example, each of the two measurement signals Sa and Sb can each be detected in the evaluation unit 21 using a double lock-in amplifier phase-sensitively with respect to the modulation of the radiation 2, where a measurement signal vector with an in-phase component and a quadrature component is produced. This will be explained below for a measurement signal S as representative, which in each case represents one of the measurement signals Sa and Sb.

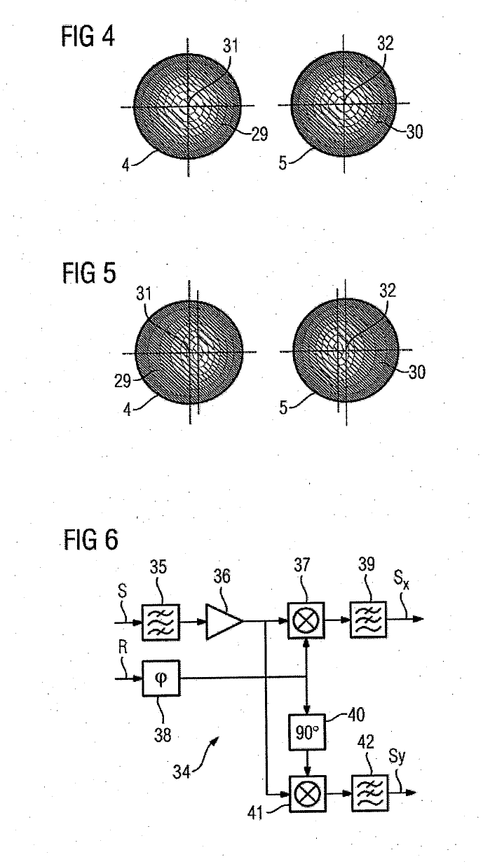

FIG. 6 shows an example of the double lock-in amplifier 34, which receives the measurement signal S as an input signal and a reference signal R from the modulator 8, in this case, for example, the light barrier shown in FIG. 3. The lock-in amplifier 34 includes, if appropriate, a bandpass filter 35 and an amplifier 36 for pre-filtering and amplifying the measurement signal S. The bandpass-filtered and amplified measurement signal S is multiplied in a phase-sensitive detector 37 by the reference signal R and in this way demodulated in a phase-sensitive manner. To this end, the reference signal R can pass through a phase shifter 38 beforehand to make possible phase matching between the reference signal R and the measurement signal S. Subsequently, the demodulated measurement signal is integrated in a low pass filter 39 to obtain the in-phase component Sₓ=S·cosφ. In order to obtain the quadrature component S_{y}=S·sinφ, the bandpass-filtered and amplified measurement signal S is multiplied in another phase-sensitive detector 40 by the reference signal R, which has been phase-shifted beforehand in another phase shifter 41 by 90°, and subsequently integrated in a further low pass filter 42.

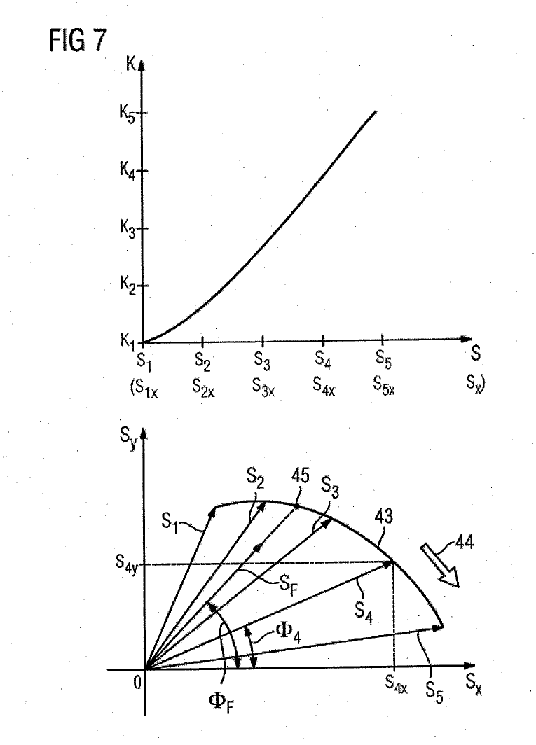

FIG. 7 shows, in the bottom part, various measurement signal vectors S₁, S₂, S₃, S₄ and S₅ in a Cartesian coordinate system. The measurement signal vectors S₁, S₂, S₃, S₄ and S₅ were ascertained in a calibration of the gas analyzer for various concentrations K₁, K₂, K₃, K₄ and K₅ of the measurement gas component in the presence of known cross gas concentrations. The measurement signal vector S₁ was ascertained with zero gas and the measurement signal vector S₅ with span gas. The measurement signal vectors S₁, S₂, S₃, S₄ and S₅ differ from one another in terms of amplitude and phase angle, where the vector component in the x-direction of the coordinate system corresponds to the in-phase component and the vector component in the y-direction corresponds to the quadrature component of the respective measurement signal vector. Thus, the measurement signal vector S₄ has the in-phase component S₄ₓ=S₄·cosφ₄ and the quadrature component S_{4y}=S₄·sinφ₄. The phase angle φ₄ results from the angle distance, viewed in the rotation direction of the chopper 8, between the light barrier 33 supplying the reference signal R and the cells 4, 5, from the phase shift φ by the phase shifter 38 and signal propagation times in the double lock-in amplifier 34 and from the measurement gas- and cross gas-dependent phase information produced by the phase imbalance in the switching of the radiation 2 between the measurement cell 4 and the reference cell 5 in conjunction with the radiation absorption in the measurement cell 4. The measurement signal vectors S₁, S₂, S₃, S₄ and S₅ define a characteristic curve 43 which can be stored as a table, where intermediate values of the characteristic curve 43 can be formed by interpolation of the recorded measurement signal vectors S₁, S₂, S₃, S₄ and S₅. The characteristic curve 43 can also be stored in the evaluation unit 21 as a mathematical function f(Sₓ, S_{y}) describing it.

The top part of FIG. 7 shows the dependence of the concentration K of the measurement gas component on the amplitude (length) of the measurement signal vectors S. When measuring an unknown concentration K of the measurement gas component, with unchanged cross gas concentrations and on the proviso that no changes have occurred at the gas analyzer since its calibration, a measurement gas vector S is obtained, the head of which is located on the characteristic curve 43. The current concentration of the measurement gas component is then determined in the evaluation unit 21 from the length of the measurement signal vector S.

In the exemplary illustrated embodiment, one value of the in-phase component Sₓ is assigned bijectively (one-to-one correspondence) to each point on the characteristic curve 43. As a result, it is also possible to use, rather than the length of the measurement signal vector S, its in-phase component Sₓ to determine the current concentration of the measurement gas component. In comparison, in the exemplary embodiment shown, it is not possible to use the quadrature component S_{y} because different points on the characteristic curve 43 within a partial region of the characteristic curve 43 have the same quadrature component. By setting the angle distance, viewed in the rotation direction of the chopper 8, between the light barrier 33 and the cells 4, 5 or the phase shift φ by the phase shifter 38, however, the characteristic curve 43 can be rotated in the direction of the arrow 44 about the origin 0 of the coordinate system until each point on the characteristic curve 43 has bijectively assigned to it one value of the quadrature component S_{y}. Then the quadrature component S_{y} can also be used to determine the current concentration of the measurement gas component.

If, owing to ageing-, dirt- or temperature-related changes at the infrared radiation source 1 or detector array 10, the intensity of the generated or detected infrared radiation 2 changes with respect to the calibration state of the gas analyzer, this results during the measurement in a measurement signal vector S_{F}, the head of which is located outside the characteristic curve 43. As already explained, however, because of these intensity changes of the infrared radiation 2, which affect the beam paths in the two cells 4 and 5 in equal measure, only the amplitude and not the phase of the measurement signal vector S_{F} is influenced. The measurement signal vector S_{F} can therefore be corrected in a simple manner, by being lengthened or shortened up to the characteristic curve 43 while keeping its phase angle φ_{F}. From the intersection point 45 of the measurement signal vector s_{F} or its extension with the characteristic curve 43, it is then possible, as already explained above, to ascertain the unknown concentration of the measurement gas component. The length of the uncorrected measurement signal vector S_{F} with respect to the length of the measurement signal vector S_{F}, which has been corrected up to the point 45 on the characteristic curve 43, is a measure of the quality of the measurement signal S_{F} and can be output by the evaluation unit 21 together with the measurement result M.

In measurement practice, however, not only the concentration of the measurement gas component in the measurement cell 4 but also that of the cross gases is variable, with the result that, on account of the previously explained separation of amplitude information and phase information of the measurement signal, a distinction is made only between the influence of the measurement and cross gases on the measurement result M, on the one hand, and the influence of changes at the infrared radiation source 1 and detector array 10 on the measurement result M, on the other hand. The distinction between the influence of the measurement gas on the measurement result M and the influence of the cross gases on the measurement result M is made by generating the two (or more) measurement signals Sa and Sb, which are evaluated using the calibration matrix 22 after correction in a correction unit 46 of the evaluation unit 21 according to the method described in connection with FIGS. 6 and 7, as was explained in connection with FIGS. 1 and 2.

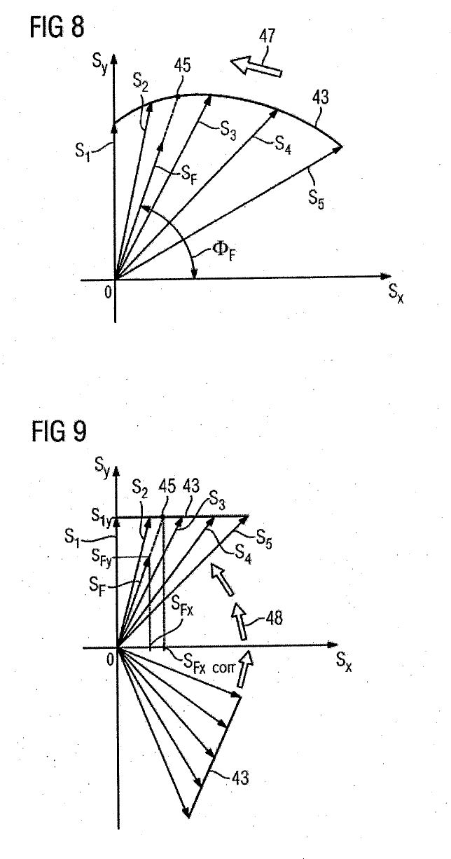

As already mentioned, the characteristic curve 43 can be stored in the correction unit 46 of the evaluation unit 21 as a table or a mathematical function f(Sₓ, S_{y}). In order to simplify the function f(Sₓ, S_{y}) and to reduce the computational complexity for correcting the measurement signal vector S_{F}, it is possible, as shown in FIG. 8, by way of setting the angle distance, viewed in the rotation direction of the chopper 8, between the light barrier 33 and the cells 4, 5 or the phase shift φ by the phase shifter 38, for the characteristic curve 43 to be rotated in the direction of the arrow 47 about the origin 0 of the coordinate system until the measurement signal vector S₁, obtained for the zero gas, or alternatively the measurement signal vector S₅ for the span gas, coincides with one of the axes of the coordinate system, in this case, for example, the y-axis.

FIG. 9 shows the special case where the characteristic curve 43 is exactly or approximately linear. By setting the angle distance, viewed in the rotation direction of the chopper 8, between the light barrier 33 and the cells 4, 5 or the phase shift φ by the phase shifter 38, it is possible here, too, for the characteristic curve 43 to be rotated in the direction of the arrow 48 about the origin 0 of the coordinate system until the characteristic curve 43 is parallel to one of the axes of the coordinate system, in this case for example the x-axis. For each point on the characteristic curve 43, the quadrature component is then S_{1y}. In the case of a measurement signal vector S_{F} with the in-phase component S_{Fx} and the quadrature component S_{Fy}, the in-phase component S_{Fx} can be corrected in a simple manner by S_{Fx corr=}S_{1y}·(S_{Fx}/S_{Fy}).

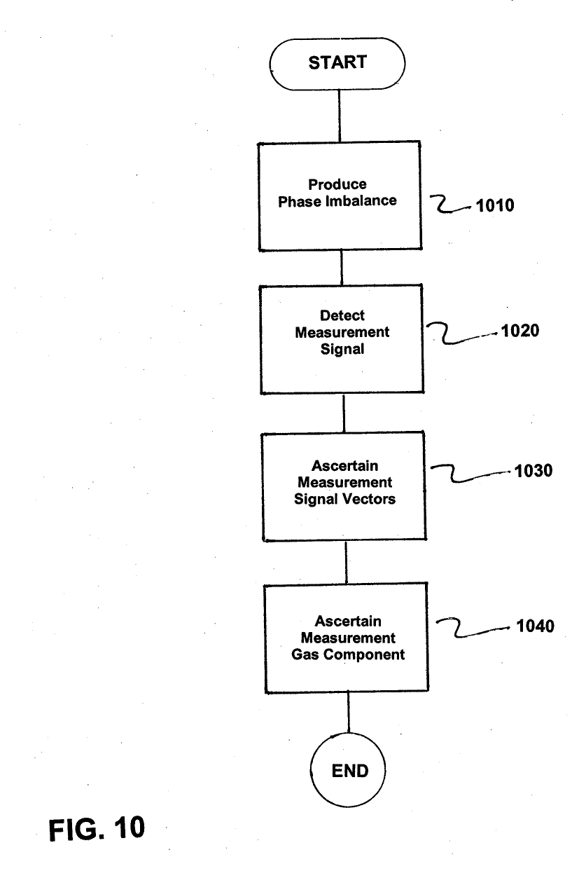

FIG. 10 is a flow chart of a method for determining the concentration of a measurement gas component in a gas mixture using a non-dispersive infrared (NDIR) two beam gas analyzer, where infrared radiation is guided alternately, by modulation, through a measurement cell receiving the gas mixture and through a reference cell containing a reference gas and subsequently detected with a measurement signal being generated, and a concentration of the measurement gas component is determined by evaluating the measurement signal. The method comprises producing a phase imbalance while switching the infrared radiation between the measurement cell and the reference cell, as indicated in step 1010.

The measurement signal is detected phase-sensitively with respect to the modulation of the infrared radiation to obtain a measurement signal vector with amplitude information and phase information, as indicated in step 1020.

Measurement signal vectors of different amplitude and phase are ascertained for different known concentrations of the measurement gas component during a calibration of a gas analyzer, as indicated in step 1030. Here, the measurement signal vectors define a characteristic curve.

An unknown concentration of the measurement gas component is ascertained in the measurement of an unknown concentration of the measurement gas component from an intersection point of a measurement signal vector, obtained in the measurement, or its extension with the characteristic curve, as indicated in step 1040.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-16. (canceled)

17. A method for determining the concentration of a measurement gas component in a gas mixture using a non-dispersive infrared (NDIR) two beam gas analyzer, the method comprising:
guiding alternately infrared radiation, by way of modulation, through a measurement cell receiving the gas mixture and through a reference cell containing a reference gas;
producing a phase imbalance while switching the infrared radiation between the measurement cell and the reference cell;
detecting, phase-sensitively with respect to the modulation, the infrared radiation existing the measurement cell and the reference cell and generating a measurement signal to obtain a measurement signal vector with amplitude information and phase information;
ascertaining, for different known concentrations of the measurement gas component during a calibration of a gas analyzer, measurement signal vectors of different amplitude and phase, the measurement signal vectors defining a characteristic curve; and
ascertaining, in the measurement of an unknown concentration of the measurement gas component, the unknown concentration of the measurement gas component from an intersection point with the characteristic curve of one of a measurement signal vector, obtained in the measurement, and an extension of the measurement signal vector.

18. The method as claimed in claim 17, wherein the phase-selective detection of the measurement signal occurs using a double lock-in amplifier, with an in-phase component and a quadrature component of the measurement signal vector being obtained.

19. The method as claimed in claim 18, further comprising:
performing a phase shift between modulation of the infrared radiation and the phase-selective detection of the measurement signal to rotate the characteristic curve in a coordinate system formed by the in-phase component and quadrature component until one of a measurement signal vector, obtained in the calibration of the gas analyzer with zero gas, and a measurement signal vector, obtained in the calibration with span gas, coincides with an axis of the coordinate system.

20. The method as claimed in claim 18, wherein an at least approximately linear profile of the characteristic curve in the coordinate system is formed by the in-phase component and quadrature component, the method further comprising:
performing a phase shift between the modulation of the infrared radiation and the phase-sensitive detection of the measurement signal to rotate the characteristic curve in the coordinate system until the characteristic curve is parallel to an axis of the coordinate system.

21. The method as claimed in claim 20, wherein for calibration, only a measurement signal vector is determined for zero gas and another measurement signal vector for span gas.

22. The method as claimed in claim 17, wherein a distance between a head of the measurement signal vector and the characteristic curve is detected and output as a deviation of the gas analyzer from a calibration state.

23. The method as claimed in claim 17, wherein an axis of rotation of a chopper or paddle wheel used for modulating the infrared radiation is displaceable with respect to axes of the measurement cell and the reference cell to set a phase imbalance while switching the infrared radiation between the cells.

24. The method as claimed in claim 17, wherein a distance between the measurement cell and the reference cell is settable to set a phase imbalance while switching the infrared radiation between the cells.

25. The method as claimed in claim 17, wherein the infrared radiation is introduced into the measurement cell and reference cell using a beam splitter asymmetrically to axes of the measurement and reference cells to set a phase imbalance while switching the infrared radiation between the measurement cell and the reference cell.

26. A non-dispersive infrared (NDIR) two beam gas analyzer for determining the concentration of a measurement gas component in a gas mixture, comprising:
an infrared-radiation source configured to generate infrared radiation;
a measurement cell receiving the gas mixture, the infrared radiation being passable through the measurement cell;
a reference cell containing a reference gas, the infrared radiation being passable through the reference cell;
a modulator arranged to periodically switch the infrared radiation between the measurement cell and the reference cell;
a detector array configured to detect the infrared radiation exiting the measurement cell and reference cell and to generate a measurement signal;
an evaluation unit configured to determine the concentration of the measurement gas component from the measurement signal;
a modulator configured to produce a phase imbalance in the switching of the radiation between the measurement cell and reference cell;
a device configured to detect the measurement signal phase-sensitively with respect to the modulation of the infrared radiation and to produce a measurement signal vector with amplitude information and phase information;
a correction unit configured to produce a characteristic curve from measurement signal vectors of different amplitude and phase, the measurement signal vectors being produced during calibration of a gas analyzer for different known concentrations of the measurement gas component in the gas mixture, and for configured to determine an unknown concentration of the measurement gas component from an intersection point of one of the measurement signal vector, obtained in the measurement of the unknown concentration of the measurement gas component, and an extension of the measurement signal vector.

27. The non-dispersive infrared (NDIR) two beam gas analyzer as claimed in claim 26, wherein the device configured to phase-sensitively detect the measurement signal comprises a double lock-in amplifier which produces an in-phase component and a quadrature component of the measurement signal vector.

28. The non-dispersive infrared (NDIR) two beam gas analyzer as claimed in claim 27, further comprising
a phase shifter configured to perform a phase shift between the modulation of the infrared radiation and the phase-sensitive detection of the measurement signal such that the characteristic curve in a coordinate system formed by the in-phase component and the quadrature component is rotated until one of a measurement signal vector, obtained during calibration of a gas analyzer with zero gas, and a measurement signal vector, obtained during calibration with span gas, coincides with an axis of the coordinate system.

29. The non-dispersive infrared (NDIR) two beam gas analyzer as claimed in claim 27, further comprising:
a phase shifter configured to perform a phase shift between the modulation of the infrared radiation and the phase-sensitive detection of the measurement signal such that, with an at least approximately linear profile of the characteristic curve in the coordinate system formed by the in-phase component and quadrature component, the characteristic curve is rotated until characteristic curve is parallel to an axis of the coordinate system.

30. The non-dispersive infrared (NDIR) two beam gas analyzer as claimed in claim 26, wherein the modulator comprises a chopper or paddle wheel having a rotational axis and is displaceable with respect to axes of the measurement cell and the reference cell to set a phase imbalance during the switching of the infrared radiation between the cells.

31. The non-dispersive infrared (NDIR) two beam gas analyzer as claimed in the claim 26, wherein a distance between the measurement cell and the reference cell is settable to set a phase imbalance during the switching of the infrared radiation between the cells.

32. The non-dispersive infrared (NDIR) two beam gas analyzer as claimed in claim 26, further comprising:
a beam splitter arranged to introduced the infrared radiation is introduced into the measurement cell and reference cell asymmetrically to axes of the two cells to set a phase imbalance during the switching of the infrared radiation between the cells.
